(19) United States
(12) Patent Application Publication
(10) Pub. No.: US 2003/0217014 A1
(43) Pub. Date: Nov. 20, 2003

(54) Systems and methods for storing and using phone number validations

(76) Inventors: Cassandra Mollett, Houston, TX (US); Steven Geiler, Friendswood, TX (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/434,536

(22) Filed: May 9, 2003

Related U.S. Application Data
(60) Provisional application No. 60/381,756, filed on May 17, 2002.

(51) Int. Cl. G06F 17/60

(52) U.S. Cl. 705/75

(57) ABSTRACT

Systems and methods are described for storing the results of telephone number validation determinations that are made in association with proposed financial transactions. In some embodiments, a telephone number validation determination is performed by dialing a telephone number in question and by perceiving a tone emitted in response to the call. In one embodiment, a record of a telephone number validation determination comprises the telephone number, an indication of whether the number is determined to be valid or non-valid, and a date on which the validation determination was performed. Systems and methods are also described for using stored telephone number validation information for subsequent telephone number validation determinations, such that the validity or non-validity of telephone numbers for which acceptable validity information is stored may be determined by accessing the stored data, if desired, rather than by dialing the telephone number.

This application claims the benefit of priority under 35 U.S.C. §119(e) of U.S. Provisional Application No. 60/381,756 filed on May 17, 2002 and entitled SYSTEMS AND METHODS FOR VALIDATION OF PHONE NUMBERS, the entirety of which is incorporated herein by reference.

### REFERENCE TO RELATED APPLICATIONS

The present application is a member of the set of related, co-pending, and commonly owned U.S. patent applications having the following titles, each of which was filed on even date herewith:

1. SYSTEMS AND METHODS FOR VALIDATION OF PHONE NUMBERS

2. SYSTEMS AND METHODS FOR STORING AND USING PHONE NUMBER VALIDATIONS

3. SYSTEMS AND METHODS FOR ACCESSING AND USING PHONE NUMBER VALIDATION INFORMATION

4. SYSTEMS AND METHODS FOR SELECTIVE VALIDATION OF PHONE NUMBERS

5. SYSTEMS AND METHODS FOR USING PHONE NUMBER VALIDATION IN A RISK ASSESSMENT

### BACKGROUND OF THE INVENTION

1. Field of the Invention

The invention relates generally to authentication systems and, more specifically, to methods of risk analysis.

2. Description of the Related Art

Promissory payments accepted by a merchant during a point-of-sale purchase or other financial transaction may expose the merchant to some risk of non-payment. Some examples of such promissory payments are payments made by check, credit card, debit card, private label, gift card, and other methods.

Several methods and services are available to help merchants manage risk at point-of-sale and other financial transactions. One example of such a method is the maintenance of a “negative database,” which, in one embodiment, is a list or database of known problematic check-writers for comparison with a current check-writer who is offering to pay for a transaction with a promissory payment. Risk assessment scoring methods may also be used to assist in judging the desirability of entering into a current transaction.

However, in spite of the use of such methods, losses from point-of-sale and other financial transactions continue to occur. Methods that are able to help further reduce the risk of such transactions, especially methods that do not make undue additional demands in terms of required resources, such as equipment, time, or cost, therefore, continue to be useful.

From a risk management point of view, receiving supplemental forms of identification for a check-writer, or other payor, together with a promissory payment is often desirable. However, because of privacy issues, customers are often increasingly hesitant to give personal identity information, such as a Social Security Number or even a driver's license number. Point-of-sale transactions executed in person, over the telephone, or over the Internet or other wired or wireless computer system often pose the additional constraint that a decision regarding acceptance or denial of an offered promissory payment be made while the customer waits for the transaction to be completed. Merchants thus face the problem of finding methods to decrease their risk in ways that are acceptable to their customers.

### SUMMARY OF THE INVENTION

Embodiments of a system that validates phone numbers received in conjunction with an overall financial transaction acceptance system are described. Typically, if a phone number that is offered by a customer or other entity in conjunction with a financial transaction may be verified as being a valid working phone number, the statistically calculated risk of the transaction decreases. Thus, information about the validity of a telephone number offered in association with a financial transaction may be used as a factor in a larger risk assessment of the transaction and may additionally or alternatively be used alone as an indication of the risk associated with a transaction.

In one embodiment of the phone number validation systems described herein, a point-of-sale (POS) device with a telephone line connection accepts a phone number from a customer who is offering a promissory payment and dials the phone number during the transaction process to confirm that the telephone number is a working number. In other embodiments, the phone number validation system is used in conjunction with a request by an entity, made online, in person, via telephone or other communications method, to purchase a good or service, open a bank account, purchase insurance, or enter into another type of financial agreement that may pose a financial risk. For example, phone validation may be used as part of a consumer authentication for a membership program.

Automatic dialer systems, commonly used in the telemarketing and debt collection industries, exist that enable a telephone to recognize a distinctive tone (for example, a 914 Hz sine wave) that telephone networks may use to indicate that a non-valid telephone number has been dialed. Using automatic dialer technology, POS devices with telephone connections may be configured to dial a given telephone number and to distinguish between working and non-working numbers. The POS device may be further configured to make such a call to a number offered in conjunction with a proposed transaction and to notify a clerk associated with the transaction of the results. In the case of a number that is dialed and found to be non-working, the POS may thereby alert the clerk to a potentially risky transaction. Information about the validity or non-validity of a given telephone number may additionally or alternatively be provided to a risk scoring system as a factor in a risk analysis of the transaction.

Using a customer's telephone number as an additional form of identification for risk assessment purposes at a point-of-sale transaction has several advantages. One advantage is the fact that customers often find the idea of giving out their current phone number to be less offensive and worrisome than revealing other types of identification information, such as a Social Security Number. Another advantage of using a customer's phone number as an input to a risk analysis for a financial transaction is the fact that, unlike many other forms of identification in use across the United States, telephone numbers have a standardized length and format, making them easier to incorporate into a computer-implemented transaction system than non-standardized identifiers, such as driver's licenses.

From a point-of-sale risk management perspective, telephone numbers are additionally useful because customers whose intention it is to commit fraud may not know the true number associated with a payment instrument they wish to use, and may decide to make up a number when asked for their telephone number. Customers attempting to commit fraud may also make up numbers because they do not want to give their true phone numbers. Furthermore, customers who habitually commit fraud are known to typically relocate frequently, and may thus not have a correct number to give.

Phone numbers collected to reduce risk as described above may additionally be used for contacting a consumer in the case of unpaid or disputed payments and may also be collected for marketing or other purposes.

In one embodiment, a retrievable record is kept of telephone numbers for which validations have been carried out and of the results of the validation checks performed. For subsequent transactions, in addition to or as an alternative to dialing the telephone number offered by the customer, the POS device may attempt to verify the given telephone number by referring to one or more retrievable records that comprise information about telephone numbers that have been previously determined to be valid or non-valid.

In one embodiment, prior to dialing the telephone number offered by a customer or other entity desirous of participating in a financial transaction, or as an alternative to dialing the telephone number, the POS device may consult stored information that may be indicative of the validity or probable validity of the telephone number.

As one example, the POS device may consult a list of telephone number prefixes associated with the telephone area code offered by the customer. If the prefix of the telephone number offered by the customer does not appear on the list, the POS device may determine that the telephone number is not valid, without any need for actually dialing the telephone number. Other types of stored information may also be accessed to gain an indication of whether the telephone number conforms to rules governing valid telephone number combinations.

The stored information may be stored within at least one of: memory in the POS device, memory in a local host computer accessible by the POS device, and memory in a remote host computer accessible by the POS device.

In one embodiment, customer telephone numbers are requested in association with transactions, and the telephone numbers offered are validated for a subset of the transactions. For example, in one embodiment, telephone numbers may be validated for purchase transactions that exceed a threshold dollar amount. In other embodiments, the telephone numbers may be validated for transactions that meet another criterion or that are selected at random. Thus, any outlay of resources, such as time, money, or computer resources, is avoided for the instances in which no check is made, while a deterrent effect upon customers wishing to commit fraud may be exerted by the simple act of asking for and selectively checking telephone numbers.

In one embodiment, phone number validation is carried out as part of a larger risk assessment for the transaction. For example, a third party service that assists merchants to minimize their risk of point-of-sale loss by assessing the risk associated with a financial transaction may incorporate phone number validation results as part of a risk assessment that comprises a risk scoring process. Thus, the results of a phone number validation may be considered as a factor, amongst other factors, relevant to a risk assessment for a transaction.

An embodiment of a computer storage medium is disclosed that is encoded with instructions for determining whether a telephone number provided in association with a financial transaction is a valid number or a non-valid number, and for evaluating, based at least in part on the determination, the risk of the financial transaction. The computer storage medium comprises a computer encoded instruction for receiving input that is indicative of a telephone number for an entity participating in a financial transaction. The computer storage medium further comprises a computer encoded instruction for dialing the telephone number and a computer encoded instruction for perceiving a tone emitted when the number is dialed. The computer storage medium further comprises a computer encoded instruction for determining whether the emitted tone indicates that the telephone number is a valid number or a non-valid number and a computer encoded instruction for evaluating the risk of the financial transaction, based at least in part on the determination. The computer storage medium comprises a computer encoded instruction for storing a retrievable record comprising at least one of: the telephone number, the date, and the determination. The computer storage medium further comprises a computer encoded instruction for accessing the retrievable record in association with a subsequent financial transaction in order to use information in the record to evaluate the risk of the subsequent financial transaction.

An embodiment of an apparatus is disclosed, wherein the apparatus comprises a computer processor configured to use a telephone connection to dial a telephone number to determine if the telephone number is a valid number and to use the determination to better evaluate the risk of a first financial transaction. The apparatus further comprises computer memory accessible by the computer processor, wherein the processor is further configured to store in the computer memory a retrievable record of whether the telephone number was valid or non-valid, and wherein the computer processor is further configured to access the retrievable record to evaluate the risk of a second financial transaction, based at least in part on whether the telephone number was a valid or a non-valid number.

An embodiment of a system for evaluating risk associated with a financial transaction is disclosed, wherein the evaluation is based at least in part on a determination of whether a telephone number provided in association with the financial transaction is a valid number or is a non-valid number. The system comprises: means for receiving input indicative of a telephone number from an entity participating in a financial transaction; means for determining whether the telephone number is a valid number or a non-valid number; means for evaluating the risk associated with the financial transaction, based at least in part on the determination; and means for storing the results of the determination in a retrievable record, such that the means for evaluating the risk can access the retrievable record to determine the risk of a second financial transaction, based at least in part on the stored results of the determination.

An embodiment of a computer-implemented method for evaluating the risk of a financial transaction is disclosed. The method uses a device to determine if a telephone number provided in association with a financial transaction is a valid number or is a non-valid number. The method comprises the acts of: receiving input indicative of a telephone number from an entity participating in a financial transaction; dialing the telephone number; determining whether the telephone number is a valid number or a non-valid number; and evaluating the risk of the transaction, based at least in part on the determination. The method further comprises storing the results of the determination in a retrievable record, such that, in association with subsequent transactions, evaluating the risk of the transaction can be accomplished, based at least in part on accessing the retrievable record to determine if the record indicates that the telephone number is a valid number or is a non-valid number.

For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 is a block diagram depicting one embodiment of a point-of-sale transaction processor with a telephone number validation system.

FIG. 2A is a block diagram depicting one embodiment of a point-of-sale transaction processor with a telephone number validation system and one or more associated databases.

FIG. 2B is a table depicting one embodiment of a telephone number validation status database that may be used in conjunction with a telephone number validation system.

FIG. 2C is a table depicting one embodiment of an area code/telephone prefix correlation database that may be used in conjunction with a telephone number validation system.

FIG. 2D is a table depicting one embodiment of an area code/zip code/telephone prefix correlation database that may be used in conjunction with a telephone number validation system.

FIG. 2E is a table depicting one embodiment of a customer ID/telephone number correlation database that may be used in conjunction with a telephone number validation system.

FIG. 3A is a block diagram depicting one embodiment of a merchant point-of-sale system that utilizes a third-party telephone number validation service.

FIG. 3B is a block diagram depicting one embodiment of a merchant point-of-sale system and a third-party telephone number validation service that uses phone number validation information as part of a risk analysis for a transaction occurring at the point of sale.

FIG. 4 is a flowchart that describes one embodiment of a method to use phone number validation in conjunction with a point-of-sale payment transaction.

FIG. 5 is a flowchart that describes a second embodiment of a method to use phone number validation in conjunction with a point-of-sale payment transaction.

FIG. 6 is a flowchart that describes an embodiment of a method to use phone number validation services offered by a third party in conjunction with a point-of-sale payment transaction.

### DETAILED DESCRIPTION OF THE PREFERRED EMBODIMENTS

Although detailed embodiments of the present invention are disclosed herein, it is to be understood that the disclosed embodiments are merely exemplary of the telephone number validation system and methods, which may be embodied in various forms. Therefore, specific structural and functional details disclosed herein are not to be interpreted as limiting, but merely as a basis for the claims and as a representative basis for teaching one skilled in the art to variously employ the methods in virtually any appropriately detailed structure.

For example, although the telephone number validation system is described herein as being implemented at a merchant's point-of-sale terminal, the methods disclosed may also be advantageously employed in other situations and locations in which increased confidence in the reliability of an individual is desirable.

Referring to the figures in more detail:

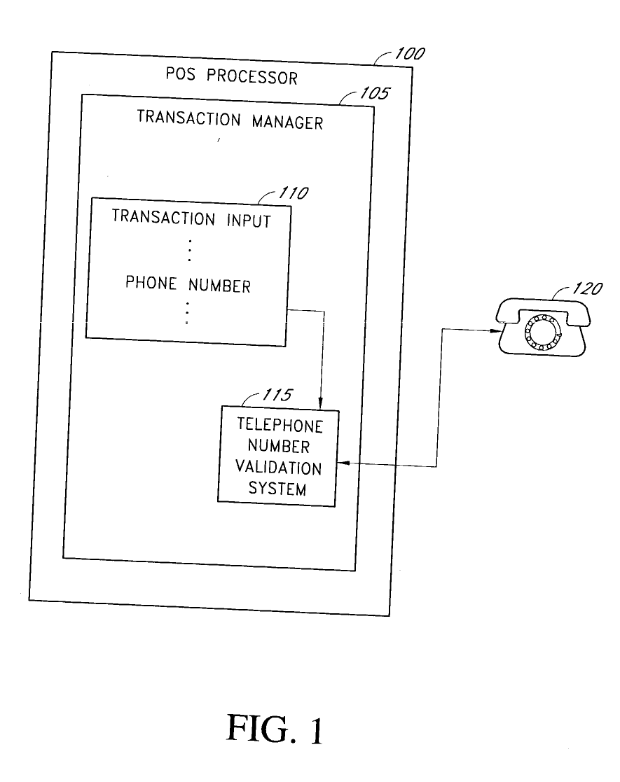

FIG. 1 depicts one embodiment of a point-of-sale (POS) transaction processor 100 that comprises a telephone number validation system 115. The POS processor 100 is configured to execute a variety of functions associated with point-of-sale transactions between a clerk, or other merchant representative, and a customer, or other entity desirous of participating in a transaction. The POS processor 100 may be deployed, for example, in association with a merchant's checkout cash register. In other embodiments, the telephone number validation system 115 is configured to operate without the presence of a merchant representative, such as in association with a self-serve checkout stand or with a server for a network-based merchant computer site that may be accessed by a suitably configured computer device. For purposes of this description, the term “customer” shall refer to an entity who desires to participate in a transaction and who offers a telephone number in conjunction with the transaction.

The POS processor 100 may be embodied, by way of example, as a personal computer (PC), mainframe computer, other processor, program logic, or other substrate configuration representing data and instructions, which operates as described herein. In other embodiments, the processor 100 may comprise controller circuitry, processor circuitry, a general purpose single-chip or multi-chip microprocessor, digital signal processor, embedded microprocessor, microcontroller and the like.

The POS processor 100 comprises a transaction manager 105 that manages transaction processes associated with a financial transaction between the clerk and the customer. The transaction manager 105 may be implemented as hardware or software or as a combination of the two. In one embodiment, the transaction manager 105 is implemented as a software plug-in for the POS processor 100.

As part of the transaction process, the transaction manager 105 prompts the clerk to input a variety of transaction input data 110 related to the current financial transaction. In the embodiment shown in FIG. 1, the transaction input 110 comprises a phone number received from the customer. In one embodiment, the clerk verbally asks the customer for a telephone number and manually inputs the phone number to the POS processor 100. In another embodiment, the customer speaks a telephone number into a suitably configured voice recognition system. In one embodiment, the phone number may be read off the face of a check offered as payment. In one embodiment, the phone number may be read electronically from an instrument in which a phone number is embedded in an electronically readable form, such as in the magnetic stripe of a driver's license. In other embodiments, other methods of inputting transaction data 110 may be used, as will be familiar to one of ordinary skill in the art.

As depicted in FIG. 1, the POS processor 100 further comprises a telephone number validation system 115, which may be activated to automatically dial the phone number 120 given for a transaction. The telephone number validation system 115 may be implemented as hardware or software or as a combination of the two. In one embodiment, the telephone number validation system 115 is implemented as a software plug-in for the POS processor 100, and may be added to existing equipment at a POS terminal.

The telephone number validation system 115 determines whether the phone number 120 received from the customer is valid or non-valid and provides this determination to the transaction manager 105 for use in managing the transaction process. In the embodiment shown in FIG. 1, the telephone number validation system 115 is configured to recognize tones indicative of working telephone numbers and tones indicative of non-working telephone numbers, and to use the tones to distinguish between the working and the non-working numbers. In one embodiment, the telephone number validation system 115 in FIG. 1 makes its determination regarding the validity or non-validity of the given telephone number by using a telephone connection associated with the POS device to dial the phone number 120 given and by perceiving the type of tone produced. The telephone number validation system 115 may then make the results of the determination available to the transaction manager 105 for use in processing the current transaction.

In one embodiment, the telephone number validation system 115 is activated to check the validity of a phone number for each transaction that involves payment by check, credit card, gift card, or other promissory form of payment. In other embodiments, the telephone number validation system 115 is activated to check the validity of a phone number for a subset of the transactions that involves payment by check, credit card, gift card, or other promissory form of payment.

For example, in one embodiment, the telephone number validation system 115 is selectively activated upon each transaction that exceeds a pre-determined dollar amount. In one embodiment, the telephone number validation system is selectively activated upon each transaction in which the given phone number 120 does not require a long-distance call. In one embodiment, the telephone number validation system is selectively activated upon each transaction in which the given phone number 120 does require a long-distance call. In one embodiment, the telephone number validation system 115 is selectively activated for randomly or near-randomly selected transactions, for example for transactions that are selected periodically based on elapsed time, based on elapsed number of transactions, based on a computerized random number generator, a pseudo-random number generator, or a near-random number generator. In other embodiments, the telephone number validation system 115 is activated for transactions that are selected based upon other criteria.

In one embodiment, the difference between a transaction for which a telephone number is requested and validated and a transaction for which a telephone number is requested and not validated is not readily apparent to the customer. Thus, the mere act of requesting telephone numbers and at least occasionally validating the telephone numbers may provide a deterrent effect upon customers wishing to perpetrate fraud.

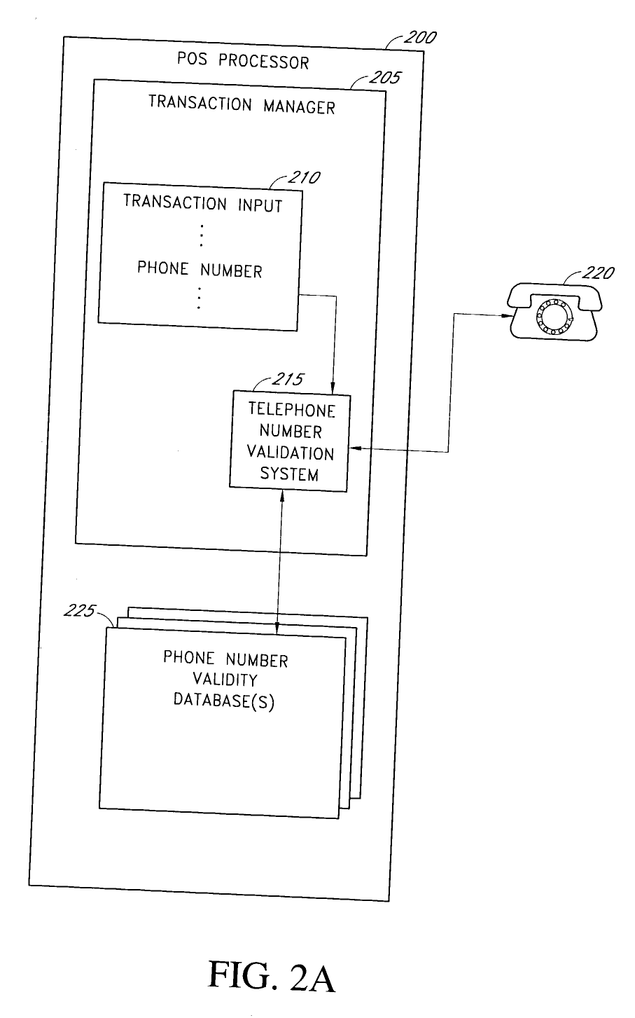

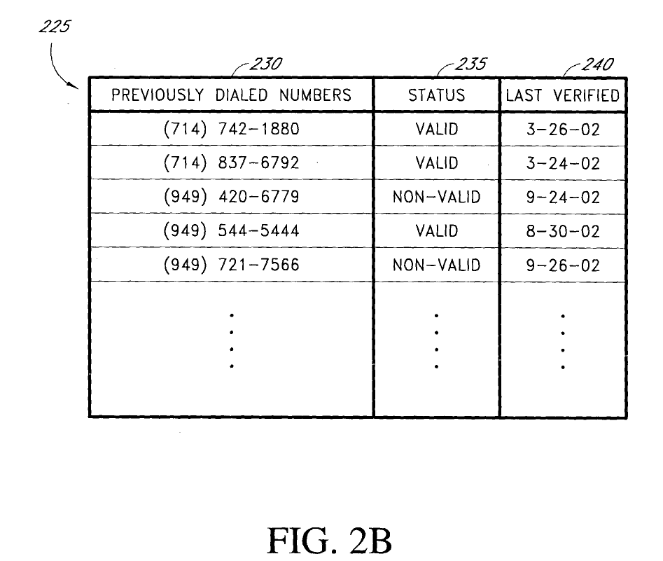

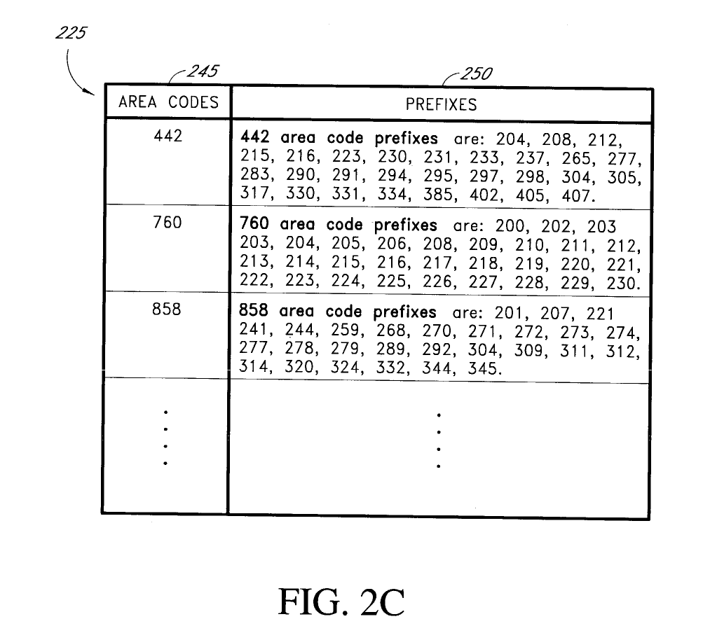

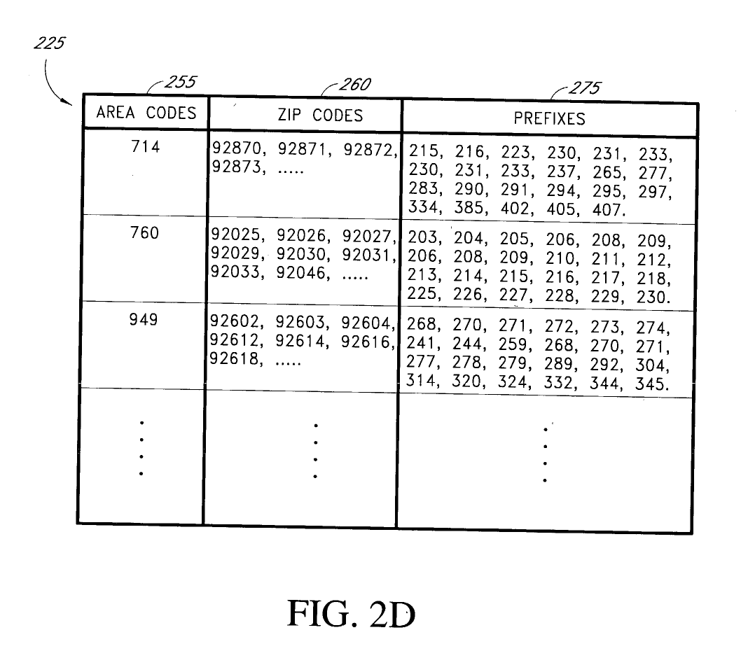

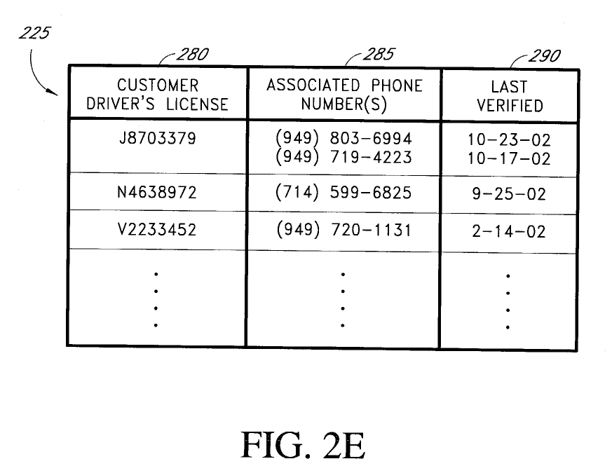

FIG. 2A depicts one embodiment of a point-of-sale processor 200 with a telephone number validation system 215 that may access information in one or more phone number validity databases 225 as part of a phone number validation process, in addition to, or as an alternative to, determining phone number validity by dialing the phone number 220 in question.

The embodiment of the POS processor 200 depicted in FIG. 2A may comprise, by way of example, a personal computer (PC), mainframe computer, other processor, program logic, or other substrate configuration representing data and instructions, which operates as described herein. In other embodiments, the processor 200 may comprise controller circuitry, processor circuitry, a general purpose single-chip or multi-chip microprocessor, digital signal processor, embedded microprocessor, microcontroller and the like.

The embodiment of the POS processor 200 depicted in FIG. 2A comprises a transaction manager 205 and a telephone number validation system 215, which checks the validity of a customer phone number received with transaction input 210 associated with the current transaction. In one embodiment, the telephone number validation system 215 is implemented as a software plug-in for the POS processor 200, and may thus be added to existing equipment at a POS terminal. The telephone number validation system 215 is configured to dial a number 220 supplied by a customer in conjunction with a desired POS transaction. The telephone number validation system 215 is further configured to refer to one or more phone number validity databases 225 for validity information in addition to or as an alternative to determining phone number validity by dialing the phone number 220 in question.

As will be described in greater detail with respect to FIGS. 2B, 2C, 2D, and 2E below, phone number validity databases 225 comprise information that may be used by the telephone number validation system 215 to assist in determining the validity or invalidity of a telephone.

Referring to one or more databases 225 of information about valid and/or non-valid telephone numbers may, in some cases, allow the telephone number validation system 215 to make a determination regarding the validity or non-validity of a telephone number offered by a customer without needing to actually dial the offered telephone number. As one example of the types of information that may be useful to a telephone number validation system 215, in some embodiments, the phone number validity databases 225 store information about telephone numbers whose validity or invalidity has been determined previously. In some embodiments, the previous determination took place when the telephone number 220 was last called and its validity or invalidity was determined based on a tone perceived by the telephone number validation system 215. In some embodiments, information about the date of the previous determination is stored with the validity determination for a telephone number.

Based at least in part on the length of time that has elapsed since the previous determination, the telephone number validation system 215 may consider the stored information to be sufficiently current and may rely on the information as relevant for the current transaction. In one embodiment, a threshold amount of elapsed time, or less, between a validation determination and its use for assessing a given transaction is considered to be acceptable. Stored information from determinations made further in the past than allowed by the threshold limit is not used in place of determinations made by dialing the telephone number. Instead, a new determination by dialing may be made, and the stored information updated to reflect the new determination. In other embodiments, other methods of defining information as being “sufficiently current” may be used.

In some embodiments, phone number validity databases 225 comprise general information about telephone number correlations and conventions that may assist the telephone number validation system 215 in determining a telephone number's validity or invalidity. For example, in various embodiments, phone number validity databases 225 may store information about valid formatting for telephone numbers, or valid pairings or correlations between telephone numbers and area codes, between telephone numbers and zip codes, or the like. In some embodiments, databases 225 of general telephone number validity information may allow the telephone number validation system 215 to determine that the telephone number offered by a customer is not valid, for example because of an unacceptable pairing of area code and a telephone number prefix in the number offered by the customer. Information from databases 225 of general telephone number validity information may allow the telephone number validation system 215 to determine that the telephone number offered by a customer matches format and/or correlation information from the database 225 and thus is possibly either a valid or an invalid number. Thus, in some embodiments, information from a phone number validity database 225 may allow for a validation determination, such as a determination of invalidity, and in some cases information from a phone number validity databases 225 may suggest or indicate the possibility of validity, while not providing a definitive determination to that effect.

In some embodiments, the telephone number validation system 215 does not dial numbers that are determined to be non-valid based on database 225 information, and may dial the telephone number 220 if information from one or more phone number validity databases 225 indicates that the telephone number 220 may be either valid or invalid.

Phone number validity databases 225 may be configured in any of a number of formats and may comprise any of a variety of data contents indicative of the validity of telephone numbers. Example embodiments of phone number validity databases 225 are depicted in FIGS. 2B, 2C, 2D, and 2E. Other embodiments of databases 225 useful to the telephone number validation system 215 are also envisioned, as will be familiar to one of ordinary skill in the art.

One or more phone number validity databases 225 accessed by the telephone number validation system 215 may be stored internally in the POS processor 200, as is depicted in the embodiment shown in FIG. 2A. One or more phone number validity databases 225 may additionally or alternatively be stored externally from the POS processor 200. For example, in one embodiment, a merchant location comprises a plurality of checkout stands with POS processors 200 that are connected via a computer network. The phone number validity databases 225 may be stored on at least one of the networked POS processors 200 and may be accessible to the telephone number validation systems 215 of the other POS processors 200 by way of the network. In another embodiment, a merchant location comprises a central merchant server or other computer that is networked to one or more POS processors 200, wherein the merchant server stores one or more phone number validity database 225 that is accessible to the POS processors 200 and that maintains a repository of data that is useful to the telephone number validation systems 215.

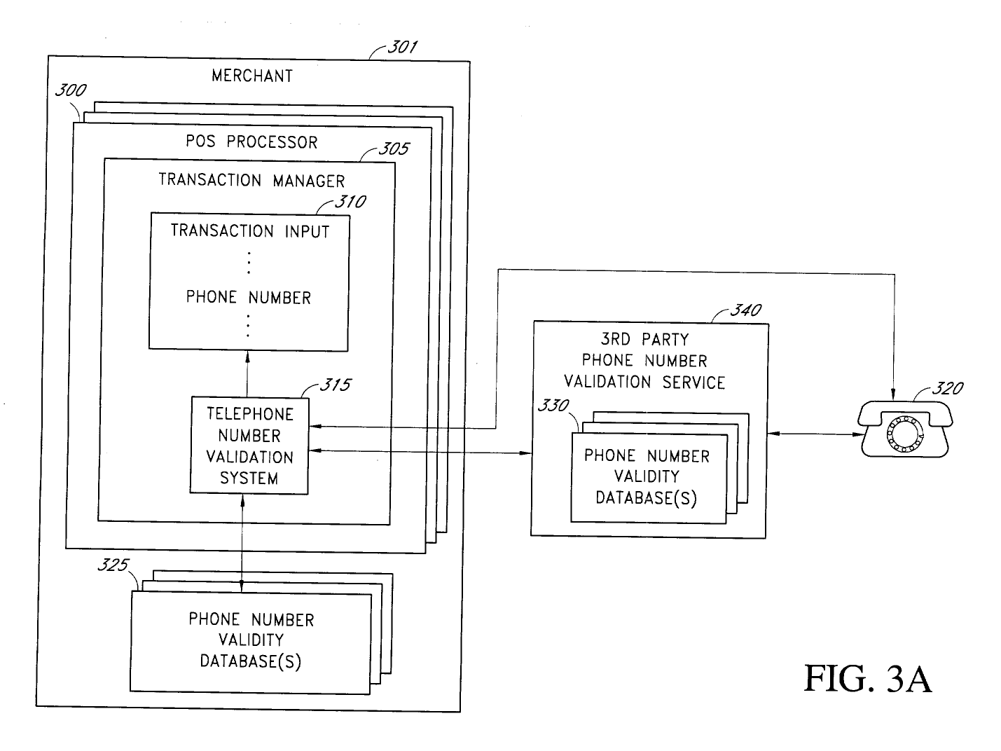

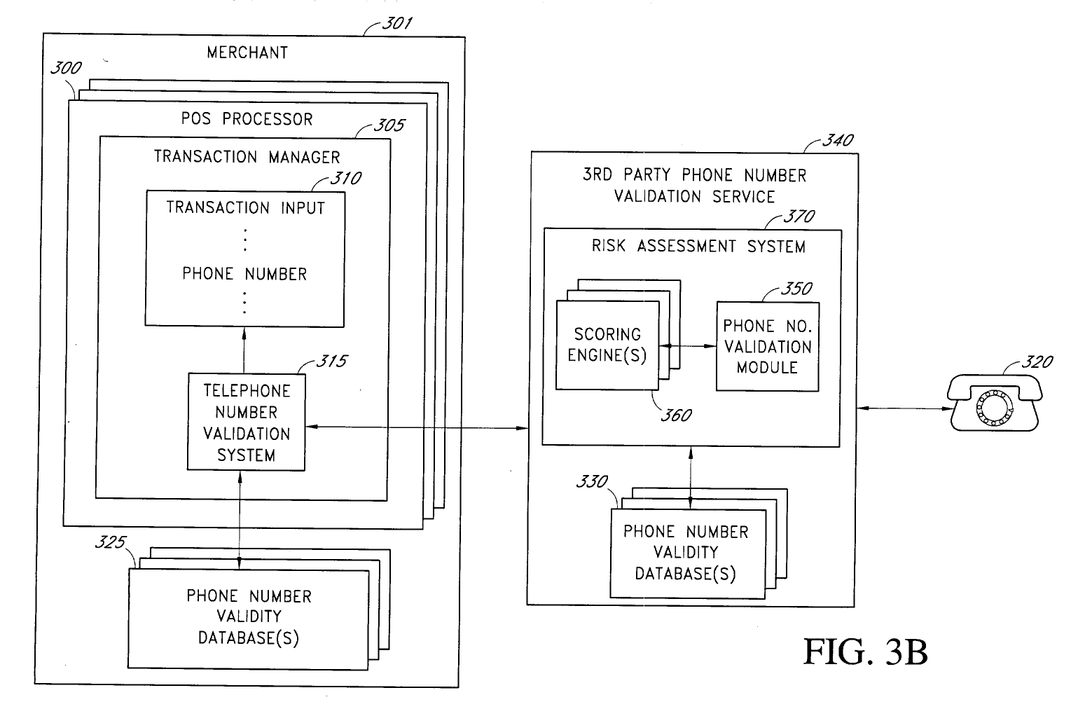

In other embodiments, one or more phone number validity databases 225 that store data useful to the telephone number validation system 215 are maintained externally to the merchant location, such as on one or more remote servers, and are accessible to the telephone number validation system 215 of a POS processor 200 via wired or wireless computer network, dedicated phone lines, or other communication means. Externally maintained phone number validity databases 225 may be maintained in storage facilities associated with the merchant location, and may be maintained by a telephone company or third party information service. Externally maintained phone number validity databases 225 may additionally or alternatively be maintained by a third party phone number validation service, as will be described in greater detail with reference to FIGS. 3A and 3B below.

In various embodiments, accessing one or more phone number validity databases 225 by the telephone number validation system 215 may be activated at a variety of times. In one embodiment, for every transaction for which a phone number validation is desired, the telephone number validation system 215 consults one or more phone number validity databases 225 to see if the databases 225 comprise information about the validity of a number 220 offered by the customer before actually dialing the phone number 220, so that placing a call may be avoided if possible.

In one embodiment, the telephone number validation system 215 consults one or more phone number validity databases 225 before actually dialing the phone number 220 when the number 220 received from the customer is a long distance number. In one embodiment, the telephone number validation system 215 consults one or more phone number validity databases 225 before actually dialing the phone number 220 when the number 220 received from the customer is not a long distance number. In one embodiment, the telephone number validation system 215 consults one or more phone number validity databases 225 before actually dialing the phone number 220 received from the customer when the amount of the proposed purchase is greater than a threshold amount. In one embodiment, the telephone number validation system 215 consults one or more phone number validity databases 225 before actually dialing the phone number 220 received from the customer when the telephone line available to the POS processor 200 is busy. In other embodiments, the telephone number validation system 215 consults one or more of the phone number validity databases 225 according to other advantageous criteria.

FIG. 2B is a table depicting one embodiment of a telephone number validation status database 225 that may be used in conjunction with a telephone number validation system 215. In one embodiment, when the telephone number validation system 115 dials the phone number 220 received from the customer, the telephone number validation system 115 may store a record of the results of the associated phone number validity determination in the phone number validity database 225, such as in FIG. 2B, so that the phone number validation information may be used in association with future transactions with the customer. In one embodiment, a phone number validity database 225 may comprise a list of phone numbers that have been tested recently and that have been found to be valid. In one embodiment, a phone number validity database 225 may comprise a list of phone numbers that have been tested recently and that have been found to be non-valid. In one embodiment, as depicted in FIG. 2B, the validity database may comprise a list of phone numbers 230 that have been dialed recently and that have been found to be valid or non-valid. The example database 225 in FIG. 2B comprises records, wherein each record comprises a phone number field 230; a status field 235 that indicates whether the phone number was found to be valid or non-valid; and a field 240 showing the date on which the information in the status field 235 was last verified by dialing or other methods.

In some embodiments, referring to the date 240 on which a given telephone number validity status 235 was last verified allows the telephone number validation system 215 to determine whether the data in the database 225 is sufficiently current to be useful to the system 215. The telephone number validation system 215 may compare the date 240 from the database 225 to a threshold date in order to determine if the information in the database 225 is sufficiently current. In one embodiment, a threshold date used to determine that records of valid phone numbers may be considered sufficiently current for use by the system 215 is different from a threshold date used to determine that records of non-valid phone numbers are sufficiently current for use by the system 215. In one embodiment, records whose date fields 240 do not meet a threshold value are purged from the database 225.

In some embodiments, a phone number validity database 225 may comprise phone number validity information received from an external source, such as from a phone company or other third party information source. For example, a phone number validity database 225 may comprise general information about the validity of various telephone number configurations. Currently, in the United States and in some other countries, standard telephone numbers comprise a three-digit area code and a seven-digit local telephone number. The first three digits of the local telephone number are known collectively as a “prefix.” Not every possible combination of three digits comprises a valid telephone area code. Similarly, not every possible combination of three digits comprises a valid prefix for use in telephone numbers within a given area code. Valid area codes are typically associated with a limited number of possible prefixes. Thus, a phone number validity database 225 that lists valid area codes and/or valid area code-prefix pairings provides information that may allow the telephone number validation system 215 to make a determination regarding the non-validity or possible validity of a telephone number offered by a customer without needing to actually dial the offered telephone number.

FIG. 2C is a table depicting one embodiment of a database 225 comprising area code/telephone prefix correlation information that may be used in conjunction with a telephone number validation system 215. As shown in the embodiment in FIG. 2C, records in the database 225 comprise an area code field 245 and a prefix field 250 that lists valid prefixes associated with each listed area code 245. In one such embodiment, if the telephone number validation system 215 accesses the database 225 and finds that there is no match between an area code and a telephone number prefix provided by a customer, the telephone may be assumed to be non-valid. Thus, in one embodiment, the system may conclude that the number is not valid, without having to actually dial the number.

FIG. 2D is a table depicting one embodiment of an area code/zip code/telephone prefix correlation database 225 that may be used in conjunction with a telephone number validation system 215. As shown in the embodiment in FIG. 2D, records in the database 225 comprise an area code field 255, a zip code field 260 that lists valid zip codes associated with each listed area code, and a prefix field 275 that lists valid prefixes associated with each listed area code.

In embodiments that refer to the type of phone number validity database 225 depicted in FIG. 2D, zip code information for the customer is used in addition to telephone number information. If the zip code does not match a zip code listed as being correlated with the area code and/or the prefix offered by the customer, the number may be assumed to be non-valid. If the zip code does match, then further investigation may determine if the number is valid or non-valid.

In one embodiment, a customer may be prompted at a point-of-sale to offer a zip code in addition to a telephone number, and the zip code may be entered manually, verbally, via magnetic stripe, or in other suitable methods that will be familiar to one of ordinary skill in the art. In one embodiment, a suitably configured device scans an image of a check or other promissory payment with imprinted address information that is offered in conjunction with a transaction. The device makes the image available to the POS processor 200. Zip code, city, and/or state information from the imprinted address may be captured using optical character recognition (OCR) technology and may be used in conjunction with a database 225 that correlates area code with city, state and/or zip code information. In one embodiment in which phone number validation is used in conjunction with an online purchase or other financial transaction, the telephone number validation system 215 may access city, state and/or zip code information from a customer's submitted billing address, home address, delivery address, or the like, in order to compare with an offered telephone number and with relevant information in a phone number validity database 225.

In some situations, where privacy protection legislation and customary business practices permit, the phone number validation system 215 may further use phone number validity databases 225 to verify that the given phone number is not only a valid number, but that it is in fact associated with the financial instrument offered or with the customer who offered the phone number as his or her own.

FIG. 2E is a table depicting one embodiment of a customer identification/telephone number correlation database 225 that may be used in conjunction with a telephone number validation system 215. In one embodiment of the customer identification/telephone number correlation database 225, the records of the database 225 comprise a customer identifier field 280, a telephone number field 285, and a verification date field 290. In the sample embodiment shown in FIG. 2E, the customer identifier field 280 comprises information about a driver's license or other government-issued identification card that is associated with a customer participating in a transaction. In other embodiments, the customer identifier field 280 may comprise one or more names of customers, or other identifiers. In the sample embodiment shown in FIG. 2E, the telephone number field 285 comprises one or more telephone numbers that have been previously determined to be valid and/or to be associated with the individual identified by information in the customer identification field 280. In the sample embodiment shown in FIG. 2E, the date field 290 comprises at least one date per telephone number appearing in the phone number field 285, indicating the date on which the phone number was last verified as being valid and/or as being associated with the individual identified in the customer identification field 280.

FIGS. 2B, 2C, 2D, and 2E have depicted some examples of data contents and storage configurations of phone number validity databases 225 that may be used by embodiments of the telephone number validation systems 215. As will be familiar to one of ordinary skill in the art, other data contents and other data storage configurations may also be used in conjunction with phone number validity databases 225 used by the telephone number validation systems 215 without departing from the spirit of the systems and methods described herein.

FIG. 3A is a block diagram depicting one embodiment of a merchant point-of-sale system 301 that utilizes a third-party phone number validation service 340. In the embodiment shown in FIG. 3A, a merchant establishment 301 comprises a plurality of POS processors 300. The POS processors 300 as depicted in FIG. 3A may comprise, by way of example, personal computers (PC), mainframe computers, other processors, program logic, or other substrate configurations representing data and instructions, which operate as described herein. In other embodiments, the processors may comprise controller circuitry, processor circuitry, general-purpose single-chip or multi-chip microprocessors, digital signal processors, embedded microprocessors, microcontrollers and the like.

As depicted in FIG. 3A, a POS processor 300 comprises a transaction manager 305 and a telephone number validation system 315 that verifies the validity of phone numbers provided as transaction input 310 in association with point-of-sale transactions. In the embodiment shown in FIG. 3A, the telephone number validation system 315 is configured to determine the validity of an offered telephone number 320 by dialing the telephone number 320, by accessing information stored in one or more phone number validity databases 325, by using the services of a third party phone number validation service 340, as will be described in greater detail below, or by any combination of the foregoing methods.

The embodiment of the telephone number validation system 315 shown in FIG. 3A is configured to make a determination as to the validity or non-validity of the telephone number 320 based at least in part on dialing the telephone number 320. The telephone number validation system 315 in FIG. 3A may additionally or alternatively access one or more phone number validity databases 325, in substantially the same manner as was described with reference to FIG. 2A above.

The phone number validity database(s) 325 may comprise information about known valid and/or non-valid telephone numbers or about general telephone number correlation information, in substantially the same manner as was described with respect to FIGS. 2A, 2B, 2C, 2D, and 2E. The phone number validity databases 325 accessible by the telephone number validation system 315 may also be created, maintained, and/or consulted in substantially the same manners as was described earlier with reference to the database(s) 225 in FIGS. 2A, 2B, 2C, 2D, and 2E. For example, as described above, the databases 325 may be configured to store a variety of types of data useful to the telephone number validation system 315. Furthermore, as described above, one or more of the databases 325 may be stored internally and/or externally to the POS processor 305 that implements the telephone number validation system 315. For example, one or more databases 325 may be stored within a location in the merchant place of business 301 that is accessible to the associated POS processors 305. The databases 325 may also be accessed selectively, as was described with respect to the databases 225 in FIG. 2A.

The embodiment of the telephone number validation system 315 shown in FIG. 3A is further configured to additionally or alternatively access a third party phone number validation service 340 that contracts with the merchant 301 to provide the merchant 301 with telephone number validation information. The embodiment of the third party phone number validation service 340 shown in FIG. 3A may directly dial the phone number 320 received from the customer in order to check the validity of the telephone number 320 based on the tone perceived when the number 320 is dialed.

The third party phone number validation service 340 may additionally or alternatively have access to one or more phone validity databases 330 that may be created, maintained, and/or consulted in substantially the same manner as the databases 225 described earlier with reference to FIGS. 2A, 2B, 2C, 2D, and 2E. For example, as described, the databases 330 may be configured to store a variety of types of data useful to the third party phone number validation service 340. Furthermore, as described above, the databases 330 may be stored internally and/or externally to the third party phone number validation service 340 that reports its findings to the telephone number validation system 315.

In one embodiment, a telephone number validation system 315 that has access to a third party phone number validation service 340 does not have direct access to communication lines for directly dialing the telephone number 320 nor direct access to phone validity databases 325. In such an embodiment, the telephone number validation system 315 may rely on the third party phone number validation service 340 to provide phone number validation information for numbers offered in conjunction with point-of-sale transactions. In one embodiment, the telephone number validation system 315 may be able to dial the telephone number 320 and may rely on the third party phone number validation service 340 to provide access to information stored in phone number validity databases 330 to which the third party phone number validation service 340 does have access.

Thus the telephone number validation system 315 may selectively use the services of the third party phone number validation service 340. In one embodiment, the telephone number validation system 315 requests validation by the third party phone number validation service 340 for every transaction that involves a promissory payment. In one embodiment, the telephone number validation system 315 requests validation by the third party phone number validation service 340 for every transaction that involves a transaction amount above a given threshold amount, and relies on direct dialing or on information gathered from phone validity databases 330 for transaction amounts at or below the threshold. In one embodiment, the telephone number validation system 315 requests validation by the third party phone number validation service 340 when the number 320 given is a long-distance number. In other embodiments, the telephone number validation system 315 requests validation by the third party phone number validation service 340 based on other advantageous criteria.

FIG. 3B is a block diagram depicting one embodiment of a merchant point-of-sale system 301 that utilizes a third-party phone number validation service 340 which provides risk assessment services for merchant transactions. In the embodiment shown in FIG. 3B, the merchant establishment 301 comprises a plurality of POS processors 300. The POS processors 300 as depicted in FIG. 3B may comprise, by way of example, personal computers (PC), mainframe computers, other processors, program logic, or other substrate configurations representing data and instructions, which operate as described herein. In other embodiments, the processors may comprise controller circuitry, processor circuitry, general-purpose single-chip or multi-chip microprocessors, digital signal processors, embedded microprocessors, microcontrollers and the like.

As depicted in FIG. 3B, a POS processor 300 comprises a transaction manager 305 and a telephone number validation system 315 that verifies the validity of phone numbers provided as transaction input 310 in association with point-of-sale transactions. The telephone number validation system 315 is configured to determine the validity of an offered telephone number 320 by dialing the telephone number 320, by accessing information stored in one or more phone number validity databases 325, by using the services of a third party phone number validation service 340, or by any combination of the foregoing methods. In the embodiment shown in FIG. 3B, the merchant point-of-sale system 301 may further contract with the third party phone number validation service 340 to provide risk assessment services for merchant point-of-sale transactions.

As depicted in FIG. 3B, the third party phone number validation service 340 comprises a risk assessment system 370 for assessing a level of risk associated with accepting the promissory payment offered by the customer to the merchant. The risk assessment system 370 depicted in FIG. 3B comprises one or more risk scoring engine(s) 360 that communicate with a phone number validation module 350. The risk assessment system 370 selects one or more of its scoring engines 360 for use in assessing a given merchant transaction. In one embodiment, the selected one or more scoring engines 360 calculate a risk score for the transaction that takes into consideration various factors that are deemed relevant to an assessment of the transaction's risk. Based on the calculated score, the third party phone number validation service 340 may recommend that the merchant point-of-sale system 301 accept the proffered promissory payment or that the merchant point-of-sale system 301 decline to accept the proffered promissory payment.

In such an embodiment, the telephone number validation system 315 of the merchant's POS processor 300 may transmit to the third party phone number validation service 340 data that may be used by the risk assessment system 370 in its assessment, according to the terms of agreement between the third party phone number validation service 340 and the merchant 301. For example, in addition to the telephone number 320 offered by the customer, the telephone number validation system 315 may transmit identifying information about the customer, about the promissory payment, and about the transaction. In one embodiment, the telephone number validation system 315 may transmit information such as the customer telephone number, name, driver's license number, check amount, check account number, type of merchant, and location of merchant. The telephone number validation system 315 may transmit information about the customer's city, state and/or zip code. In one embodiment, information used by the scoring engine 360 is assigned a value, and the values assigned to factors used by the scoring engine 360 are aggregated to produce a risk score for the transaction.

In the embodiment depicted in FIG. 3B, a scoring engine 360 may use information about the validity of a telephone number 320 offered by a customer as a factor in producing the risk score for the transaction. The information about the validity of the telephone number 320 may be determined by the telephone number validation system 315 and may be transmitted to the risk assessment system 370 for use in assessing the risk of the transaction. Alternatively, the phone number validation module 350 of the risk assessment system 370 may determine the validity of the phone number 320.

As depicted in FIG. 3B, the phone number validation module 350 may dial the telephone number 320 to determine whether the number is valid or not valid. Additionally or alternatively, the phone number validation module 350 may access information stored in one or more phone number validity databases 330. Databases 330 may be maintained internally to the third party phone number validation service 340, as is depicted in FIG. 3B. Additionally or alternatively, phone number validity databases 330 may be maintained externally to the third party phone number validation service 340 and may be accessed using any of a number of number of communications technologies.

In a system where a high score indicates a high level of confidence in the reliablity of the transaction, the risk scoring engines 360 may assign a high confidence score to a phone number 320 that is determined to be valid. A high phone validity score that is aggregated in with other risk factor scores by the scoring engine 360 may tend to raise the value of the aggregated risk score, indicating an increased confidence in the safety of the transaction. Conversely, the risk scoring engines 360 may assign a low confidence score to a phone number 320 that is determined to be non-valid. A low phone validity score that is aggregated in with other risk factor scores by the risk engines 360 may tend to lower the value of the aggregated risk score, indicating a decreased confidence in the safety of the transaction.

In various embodiments in which the scoring engines 360 aggregate scores associated with a variety of risk factors, a positive, high-value phone validity score may serve to raise an overall aggregated score, and the aggregated score may still indicate a risk level for the transaction that is unacceptable. Thus, the risk assessment system 370 may recommend declining to accept the check. Conversely, a negative, low-value phone validity score associated with a phone number that is found to be not valid may serve to lower an overall aggregated score, and the aggregated score may still indicate a confidence level for the transaction that is acceptable. Thus, the risk assessment system 370 may recommend accepting the check in spite of the invalid phone number, or may recommend double-checking the phone number before accepting the check.

In other embodiment, other methods of using phone validation information as a factor in a risk assessment for a financial transaction may be implemented without departing from the spirit of the systems and methods described herein, as will be familiar to one of ordinary skill in the art. For example, a low score may indicate a low level of risk, while a high score may indicate a high level of risk.

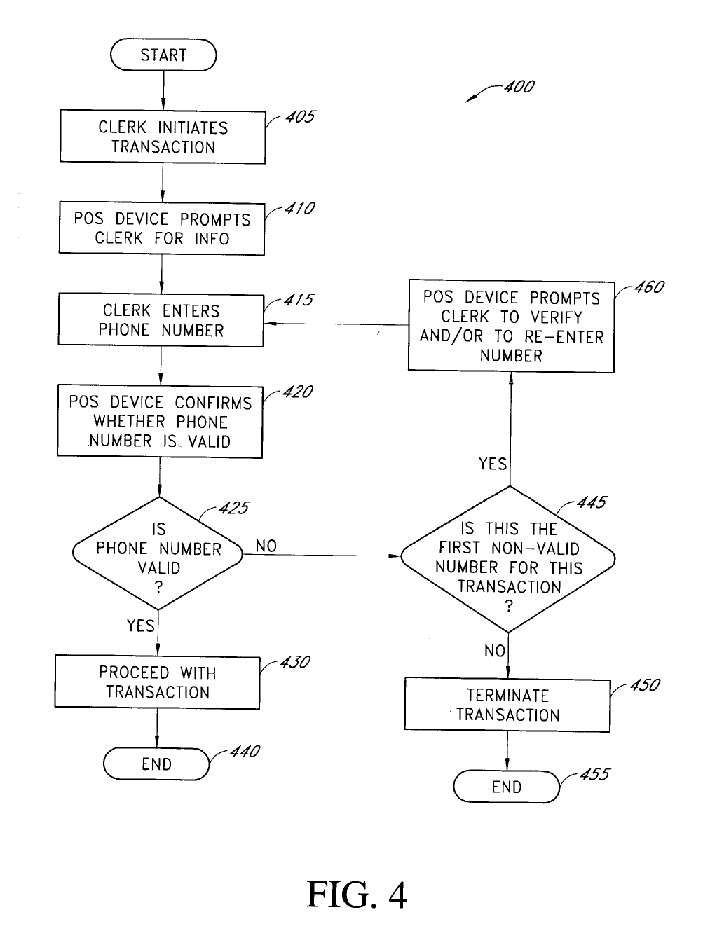

FIG. 4 is a flowchart that describes one embodiment of a process 400 to use phone number validation in conjunction with a point-of-sale financial transaction. As depicted in FIG. 4, the process 400 begins in state 405 where the clerk initiates a payment transaction for a customer on the POS processor device 100. The process 400 moves to state 410 where the POS device 100 prompts the clerk to enter information associated with the payment transaction, including a phone number provided by the customer. The process 400 moves on to state 415 where the clerk enters the phone number 120. In some embodiments, the phone number 120 is entered manually. In other embodiments, the phone number 120 may alternatively be entered via electronic scanning, voice input, or other data input methods, or may be retrieved from a stored repository of information.

The process 400 moves on to state 420 where the telephone number validation system 115 confirms whether the phone number 120 is valid. One method for confirming validity is to have the POS device 100 dial the number 120 entered for the transaction. Dialing the phone number may be executed as a background process, while the clerk and the customer continue to enter other data relevant to the payment transaction. The phone number validation process 400 meanwhile moves on to state 425 where the POS device 100 determines if the phone number 120 is valid. In one embodiment, if the POS device 100 does not detect a distinctive tone or other indicia signifying a non-working phone number, then the process 400 determines that the given telephone number is valid and moves on to state 430, where the payment transaction may proceed until it ends in state 440.

Returning to state 425, if the POS device 100 does detect a distinctive tone or other indicia signifying a non-working phone number, then the process 400 moves on to state 445, where the process 400 determines, in one embodiment, if this is the first non-working number that has been provided for the current payment transaction. In the embodiment described in FIG. 4, the process 400 allows for the entry of at most one non-valid phone number before terminating and denying the transaction. Allowing one non-valid number to be entered provides some accommodation for correcting a mistaken entry on the part of the clerk or an error on the part of the customer, without giving the customer an unlimited opportunity to offer randomly chosen numbers until one is finally determined to be valid. Other embodiments of a phone number validation system may accommodate the entry of a non-valid phone number in other ways, for example, by enforcing a different maximum number of non-valid phone numbers to be entered, by not enforcing any maximum number, or by not allowing for the entry of any additional telephone numbers after the entry of a non-valid number.

In some embodiments, when a determination regarding the validity or non-validity of the phone number 120 has been made in state 425, an appropriate notation to record the phone number and the associated determination may be stored in a phone number validity database 225, as was described in greater detail with reference to FIGS. 2A and 2B above.

As depicted in FIG. 4, if the process 400 determines in state 445 that this is not the first non-working number submitted in connection with this transaction, then the process 400 moves on to state 450, where the transaction is terminated, and finally on to state 455 where the process 400 ends.

Returning to state 445, if the process 400 determines that this is the first non-working phone number received for this transaction, then, in the embodiment depicted in FIG. 4, the process 400 moves on to state 460, where another telephone number may be submitted. In one embodiment, the process 400 causes the phone number just tested to be displayed on the POS device 100 so that the clerk may read it back to the customer and may verify that the number was entered correctly. If the number was entered incorrectly, the clerk is given another opportunity to enter the customer's phone number.

In one embodiment, when the process 400 reaches state 460, the telephone number that was just determined to be non-valid is not displayed or read back to the customer, and the clerk is prompted to again request a number for the customer. In other embodiments, other methods of identifying a number to be used in connection with this transaction are executed.

Once a phone number has been identified in state 460, the process 400 moves to state 415 where the clerk once again enters the phone number, and then on to state 425 for validation of the number, proceeding either to state 430, where the transaction is continued, or to state 450, where the payment transaction is terminated.

In one embodiment of a process to use phone number validation to assess the predicted risk associated with a proposed transaction, the process takes place at a self-serve kiosk, home, office, or other location at which no clerk or merchant representative is physically present to facilitate the transaction. In such an embodiment, functions described with reference to the flowchart in FIG. 4 as being carried out by a clerk may be carried out, in a suitably configured system, by the customer and/or by automated processes implemented at the self-serve kiosk or other location. For example, rather than having a clerk enter the customer's telephone number, as in state 415 of FIG. 4, the customer may enter the telephone number manually, by voice input, by electronic scanning, or by other input methods implemented at the self-serve kiosk. These and other adaptations are envisioned for the systems and methods described herein and will be familiar to one of ordinary skill in the art. Furthermore, systems are envisioned in which the components of the process 400 are combined and/or configured in a different manner without departing from the spirit of the systems and methods described herein.

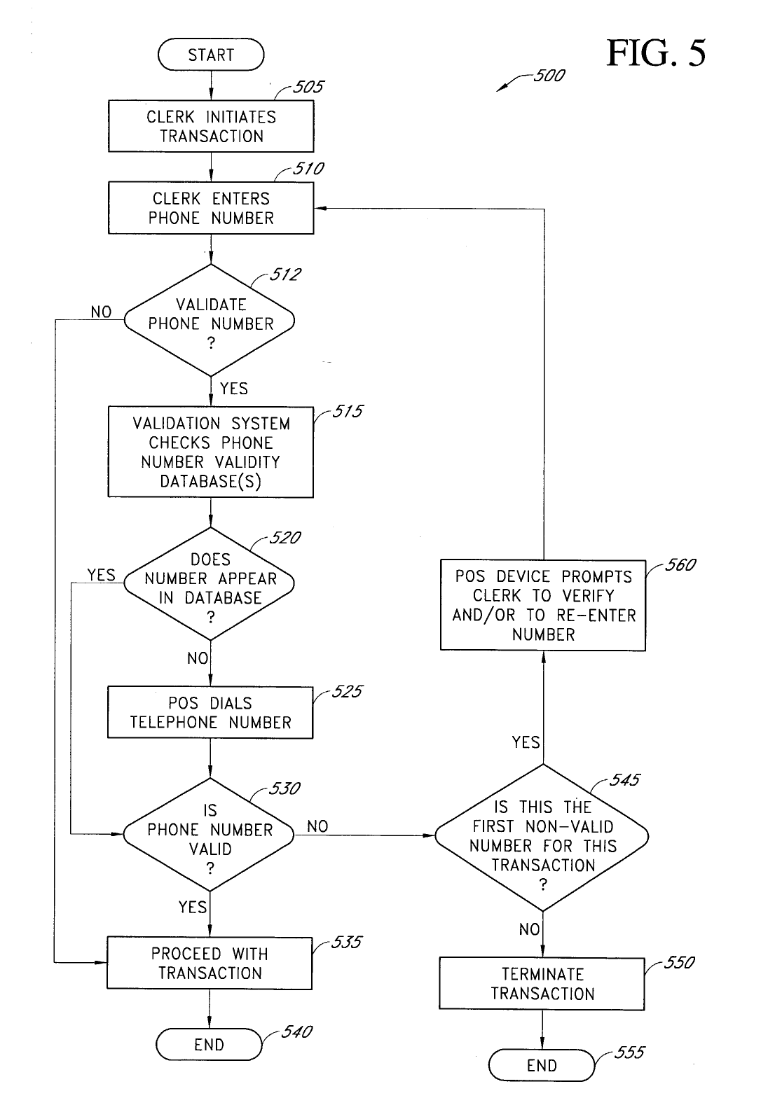

FIG. 5 is a flowchart that describes one embodiment of a process 500 to use phone number validation at a point-of-sale payment transaction in conjunction with one or more phone number validity databases 225. The process 500 begins in state 505 when a clerk initiates a payment transaction. The process 500 moves on to state 510 where the clerk enters a customer phone number 220 for this transaction.

The process 500 moves to state 512 where the system determines whether a phone number validation will be carried out in association with the current transaction. In embodiments where phone validation is carried out for a subset of the transactions, and in which phone validation is not to be carried out for the current transaction, the process 500 moves directly to state 535 where the transaction is allowed to proceed. Such a decision not to carry out a phone number validation may be based on any one of a number of criteria. For example, the amount of the transaction may be below a threshold value set for phone number validation. The telephone number may be a long distance number, and the system may be configured to validate only local telephone numbers. Telephone number validation may be carried out for only a limited number of randomly selected transactions. These and other reason may cause the process 500, in various embodiments, to allow the transaction to proceed without phone validation.

If the process 500 determines in state 512 that a phone number validation will be carried out, however, the process 500 moves on to state 515. For example, in embodiments in which a phone number validation is carried out for all transactions that involve the offer of a promissory payment, the process moves on to state 515 for all such transactions. In state 515 the telephone number validation system 215 searches one or more phone validity databases 225 for data that may be relevant to the task of determining if the entered customer phone number 220 is valid or non-valid.

A phone number validity database 225 may be configured to store at least one of many different sets of information, as was described in greater detail with reference to FIGS. 2A, 2B, 2C, 2D, and 2E. For example, a phone number validity database 225 may store phone numbers whose validity has been verified recently, together with a date when the phone numbers were last verified. A phone number validity database 225 may store non-valid phone numbers and associated dates when the non-valid numbers were last dialed. Such databases 225 may be purged regularly of records that are no longer up-to-date. In one embodiment, the process 500 may be configured to access a first database 225, and if a desired set of information is not available from the first database, to access a second database, and so on.

The phone number validity database 225 accessed may be a database that is used primarily for purposes other than phone number validation but that comprises information useful for associating a customer wishing to make a payment with a phone number provided in conjunction with the payment transaction. The phone number validity database 225 may also or may alternatively be configured to store other information useful to a phone number validation process 500, such as information about acceptable pairings of area codes and telephone number prefixes or correlations between area codes and postal zip codes.

As described with reference to FIG. 2A above, the database(s) 225 may be stored externally, such as databases maintained by a telephone service provider or other information source, and may be accessed using a communications network or other communications method.

When the process 500 has consulted the database(s) 225, the process 500 moves to state 520 where the process 500 determines if the telephone number 220 or other desired information was found in the database(s) 225. If the telephone number 220 or information was not found in a database 225, then the process 500 moves on to state 525 where the POS device 200 dials the telephone number 220 and receives a transmitted tone. The process 500 moves on to state 530 where the telephone number validation system 215 determines if the transmitted tone indicates that the phone number 220 is valid or non-valid.

Returning to state 520, if the telephone number 220 does appear in a database 225, the process 500 may move to state 530 without the need to dial the number.

In state 530, the telephone number validation system 215 determines if the phone number 220 is valid or non-valid. If the telephone number 220 is determined to be valid, the process 500 moves on to state 535, where the transaction is permitted to proceed, and the phone number validation process 500 ends in state 540.

If, in state 530, the telephone number 220 is determined to be non-valid, the process 500 moves on to state 545, where the telephone number validation system 215 determines if this is the first non-working phone number that has been processed for this transaction. The flowchart of FIG. 5 depicts an embodiment in which one additional telephone number 220 may be submitted after an original number is declared to be non-valid. However, other embodiments exist that allow for more than one additional number to be submitted or that do not allow for the submission of any additional numbers if a first number is found to be non-valid. These embodiments, although not explicitly depicted in FIG. 5, do encompass the spirit of the systems and methods described herein.

If the telephone number validation system 215 determines that this is not the first non-working phone number that has been processed for this transaction, the process moves to state 550 where the transaction is terminated 550 and the phone number validation process 500 ends in state 555.

Returning to state 545, if the telephone number validation system 215 determines that this is the first non-working phone number that has been processed for this transaction, then the process 500 moves to state 560. In state 560, another phone number 220 may now be entered, and the POS device 200 prompts the clerk to verify and/or to re-enter a telephone number 220 in order to make a second attempt at validating a phone number associated with the payment transaction. The clerk enters the current telephone number 220 in state 510, and the process 500 proceeds as described earlier, with the phone number validation process 500 either allowing the transaction to proceed 535 or terminating it 550.

Returning to state 530, in some embodiments, when a determination regarding the validity or non-validity of the phone number 220 has been made in state 530, an appropriate notation to record the phone number and associated determination may be made in a stored phone number validity database, as was described in greater detail with reference to FIGS. 2A and 2B above.

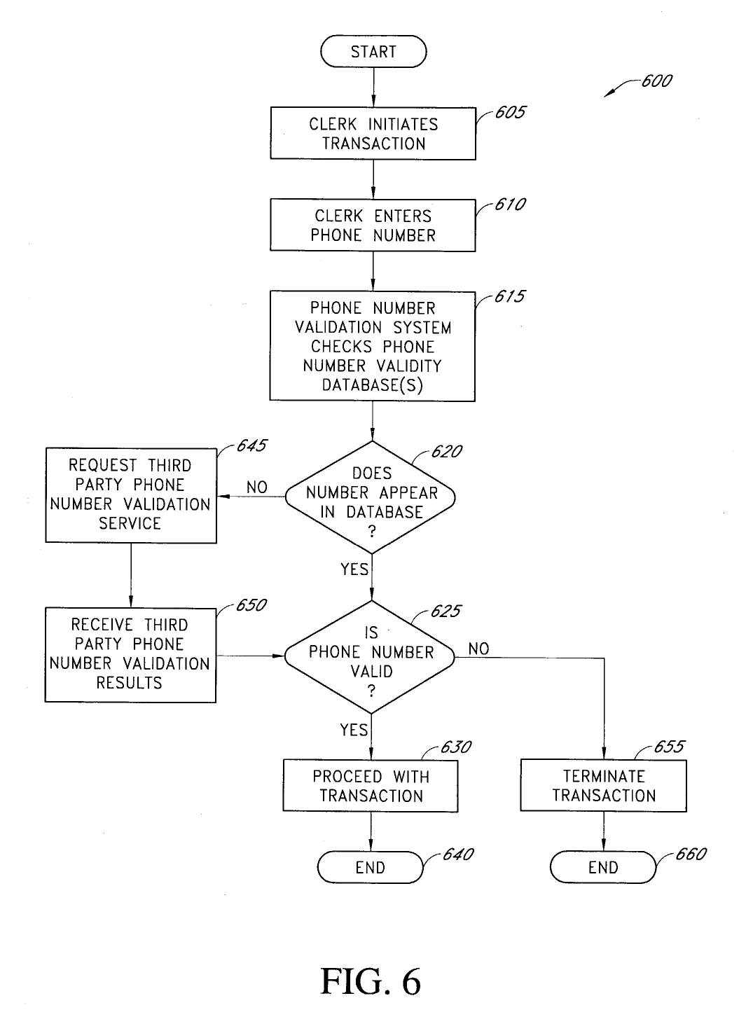

FIG. 6 is a flowchart that describes an embodiment of a process 600 to use phone number validation services offered by a third party in conjunction with a point-of-sale financial transaction. Phone number validation services, as depicted in FIG. 6, may comprise a validation determination for a given telephone number and/or may comprise a risk assessment that uses phone number validation information as a factor in a risk analysis for the transaction. The process 600 begins in state 605 in which the clerk initiates the payment transaction on the POS device 300. Moving on to state 610, the clerk enters a customer phone number 320 received in conjunction with the current transaction. In the embodiment shown in FIG. 6, in state 615, the phone number validation system 315 checks the phone number validity database(s) 325 to see if recent information about the number being valid or non-valid is stored therein, or to check for other relevant data.

In state 620, the process 600 determines if the phone number 320 in question appears in one or more validity databases 325. If the number 320 does appear in one or more databases 325, the process 600 determines in state 625 whether the stored information indicates that the number is valid or non-valid. If the database indicates that the number is valid, in some embodiments, there may be no need to call the phone number 320 or to request third party phone validation services 340. The process 600 moves to state 630 where the transaction manager 305 may proceed with the transaction, and finally in state 640, the process 600 ends.

Returning to state 625, if the stored information indicates that the number 320 is non-valid, there may be no need to call the phone number 320 or to request third party phone validation services 340. The process 600 moves to state 655 where the transaction manager 305 may terminate the transaction, and finally, in state 660, the process 600 ends.

Returning to state 620, if the phone number 320 is determined not to appear in the validity database(s) 325 checked, the process 600 moves to state 645 where phone number validation service is requested from a third party 340. The third party phone number validation service 340 assesses the validity of the telephone number 320 in question, either by referring to one or more phone number validity databases 330 to which it has access, by dialing the phone number 320, by a combination of the two, or by some other method to determine if the phone number 320 is valid or non-valid. Additionally or alternatively, the third party phone number validation service 340 may perform a risk assessment of the proposed transaction that may comprise calculating a risk score that uses phone number validation as a risk factor.

Moving from state 645 to state 650, the third party service 340 sends its determination back to the POS device 300, and in state 625, based on the results received from the third party phone number validation service 340, the process 600 either moves on to state 630, where the transaction manager 305 may proceed with the transaction, if the number 320 has been determined to be valid and/or the risk of the transaction acceptable, or, if the number 320 is determined to be non-valid or the risk of the transaction too high, the process 600 moves on to state 655 where the process 600 terminates the transaction and ends in state 660.

The embodiment described with reference to FIG. 6 is one in which the phone number validation system 315 consults one or more phone number validity databases 325 and, if sufficient information is not found in the databases 325 to make a determination of validity or non-validity, requests that the third party phone number validation service 340 check the validity of the phone number 320 received from the customer. In other embodiments, the phone number validation system 315 requests that the third party phone number validation service 340 checks the validity of the phone number 320 received from the customer without first attempting to locate the phone number 320 in one of the phone number validity databases 325. In yet other embodiments, the capabilities for checking phone number validity by dialing the number 320, by consulting appropriate databases 325 of information, and/or by requesting the services of a third party phone number validation service 340 may be combined and configured separately and in various combinations and selectively, as was has been described throughout this description.

Several embodiments of a phone number validation system have been described herein with particular applications associated with point-of-sale transactions. However, it is foreseen that the techniques described may have wider applications. As one example, situations in which it is desirable to assess the risk of a proposed agreement may appropriately incorporate the systems and methods described herein, whether the situation occurs at a point-of-sale or at some other location. Therefore, while certain embodiments of the systems and methods have been described, these embodiments have been presented by way of example only, and are not intended to limit the scope of the inventions to the specific forms, arrangement of parts, sequence of steps, or particular applications described and shown. Indeed, the novel methods and systems described herein may be embodied in a variety of other forms. For example, the functions fulfilled by the clerk in the embodiments described in FIGS. 4-6 may be carried out by an automated system rather than by an individual acting as a merchant representative. The phone number validation may be performed for a customer, as described herein, or for another type of entity desirous of participating in a transaction or for whom a confirmation of reliability is desirable. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

What is claimed is:

1. A computer storage medium having instructions encoded thereon for determining whether a telephone number provided in association with a financial transaction is a valid number or a non-valid number, and for evaluating, based at least in part on the determination, the risk of the financial transaction, the computer storage medium comprising:
a computer encoded instruction for receiving input indicative of a telephone number for an entity participating in a financial transaction;
a computer encoded instruction for dialing the telephone number;
a computer encoded instruction for perceiving a tone emitted when the number is dialed;
a computer encoded instruction for determining whether the emitted tone indicates that the telephone number is a valid number or a non-valid number;
a computer encoded instruction for evaluating the risk of the financial transaction, based at least in part on the determination;
a computer encoded instruction for storing a retrievable record comprising at least one of: the telephone number, the date, and the determination; and
a computer encoded instruction for accessing the retrievable record in association with a subsequent financial transaction in order to use information in the record to evaluate the risk of the subsequent financial transaction.

2. The computer storage medium of claim 1, wherein the computer encoded instruction for receiving input further comprises a computer-encoded instruction for receiving the information as manual input.

3. The computer storage medium of claim 1, wherein the computer encoded instruction for receiving input further comprises a computer-encoded instruction for receiving the input as spoken input.

4. The computer storage medium of claim 1, wherein the computer encoded instruction for receiving input further comprises a computer encoded instruction for receiving input that is extracted from a scanned image of a check.

5. The computer storage medium of claim 1, wherein the computer encoded instruction for receiving input further comprises a computer-encoded instruction for receiving the input as magnetically encoded information.

6. The computer storage medium of claim 1, wherein the computer encoded instruction for evaluating risk comprises a computer-encoded instruction for evaluating the risk as being lower if the telephone number is valid.

7. The computer storage medium of claim 1, wherein the computer encoded instruction for evaluating risk comprises a computer-encoded instruction for evaluating the risk as being higher if the telephone number is non-valid.

8. The computer storage medium of claim 1, wherein the computer encoded instruction for storing a retrievable record comprises a computer-encoded instruction for storing information about the transaction when the dialed telephone number is determined to be a valid number.

9. The computer storage medium of claim 1, wherein the computer encoded instruction for storing a retrievable record comprises a computer-encoded instruction for storing information about the transaction when the dialed telephone number is determined to be a non-valid number.

10. The computer storage medium of claim 1, wherein the computer encoded instruction for storing a retrievable record comprises a computer-encoded instruction for storing information about the transaction when the entity is known to be a repeat customer.

11. The computer storage medium of claim 1, wherein the computer encoded instruction for storing a retrievable record comprises a computer-encoded instruction for storing information about the transaction when the telephone number is a long distance number.

12. An apparatus, comprising:
a computer processor configured to use a telephone connection to dial a telephone number to determine if the telephone number is a valid number and to use the determination to better evaluate the risk of a first financial transaction; and
computer memory accessible by the computer processor, wherein the processor is further configured to store in the computer memory a retrievable record of whether the telephone number was valid or non-valid, and wherein the computer processor is further configured to access the retrievable record to evaluate the risk of a second financial transaction, based at least in part on whether the telephone number was a valid or a non-valid number.

13. The apparatus of claim 12, further comprising a display for displaying a recommendation based at least in part on the evaluated risk of the second financial transaction.

14. A system for evaluating risk associated with a financial transaction, based at least in part on a determination of whether a telephone number provided in association with the financial transaction is a valid number or is a non-valid number, the system comprising:
means for receiving input indicative of a telephone number from an entity participating in a financial transaction;
means for determining whether the telephone number is a valid number or a non-valid number;
means for evaluating risk associated with the financial transaction, based at least in part on the determination; and
means for storing the results of the determination in a retrievable record, such that the means for evaluating the risk can access the retrievable record to determine the risk of a second financial transaction, based at least in part on the stored results of the determination.

15. A computer-implemented method for evaluating the risk of a financial transaction by using a device to determine if a telephone number provided in association with a financial transaction is a valid number or is a non-valid number, the method comprising the acts of:
receiving input indicative of a telephone number from an entity participating in a financial transaction;
dialing the telephone number;
determining whether the telephone number is a valid number or a non-valid number;
evaluating the risk of the transaction, based at least in part on the determination, and
storing the results of the determination in a retrievable record, such that, in association with subsequent transactions, evaluating the risk of the transaction can be accomplished, based at least in part on accessing the retrievable record to determine if the record indicates that the telephone number is a valid number or is a non-valid number.

16. The method of claim 15, wherein receiving input from an entity participating in a financial transaction comprises receiving input from an entity at a point of sale at a merchant facility.

17. The method of claim 15, wherein receiving input from an entity participating in a financial transaction comprises receiving input from an entity participating in an online transaction.

18. The method of claim 15, wherein storing the results in a retrievable record further comprises storing indications of at least one of: the date of the call, the telephone number called, and of whether the tone indicated that the telephone number was valid or non-valid.

19. The method of claim 15, wherein storing the results in a retrievable record further comprises storing the results in computer memory in a point-of-sale device at a merchant facility where the financial transaction is occurring.

20. The method of claim 15, wherein storing the results in a retrievable record further comprises storing the results in computer memory at a merchant facility that is remotely accessible to a point-of-sale device where the financial transaction is occurring.

21. The method of claim 15, wherein storing the results in a retrievable record further comprises storing the results in computer memory accessible by an online server that is associated with the financial transaction.

22. The method of claim 15, wherein storing the results in a retrievable record further comprises storing the results in computer memory accessible to a computer processor at a third party phone number validation service to which a request has been sent to assess the risk of the transaction.

23. The method of claim 15, wherein storing the results in a retrievable record further comprises storing the results in computer memory accessible to a computer processor at a third party phone number validation service to which a request has been sent to determine whether the telephone number is valid or non-valid.

24. The method of claim 15, wherein storing the results in a retrievable record comprises storing the results when the dialed telephone number is determined to be a non-valid number.

25. The method of claim 15, wherein storing the results in a retrievable record comprises storing the results when the dialed telephone number is determined to be a valid number.

26. The method of claim 15, wherein storing the results in a retrievable record comprises storing the results when the dialed telephone number is a long-distance number.

27. The method of claim 15, wherein storing the results in a retrievable record comprises storing the results when the dialed telephone number is a local number.

28. The method of claim 15, wherein storing the results in a retrievable record comprises storing the results when the entity is known to be a repeat customer.

29. The method of claim 15, further comprising accessing the retrievable record in association with subsequent transactions.

30. The method of claim 29, further comprising accessing the retrievable record for subsequent transactions associated with promissory payments whose value is below a threshold value.

31. The method of claim 29, further comprising accessing the retrievable record in association with subsequent transactions in which the telephone number is a long distance number.

32. The method of claim 29, further comprising accessing the retrievable record in association with subsequent transactions in which the telephone number is a local number.

33. The method of claim 29, further comprising accessing the retrievable record in association with subsequent transactions when a telephone line available for dialing the telephone number is occupied.

34. The method of claim 29, further comprising accessing the retrievable record in association with subsequent transactions when the point-of-sale device experiences a high volume of sales.

35. The method of claim 29, further comprising, if the date indicated in the retrievable record is earlier than a threshold value, the acts of:
dialing the telephone number a subsequent time;
perceiving a tone emitted when the telephone number is dialed a subsequent time; and
replacing the retrievable record associated with the telephone number with an updated retrievable record.

36. The method of claim 29, further comprising deleting the retrievable record associated with the telephone number when a threshold amount of time has elapsed since the date in the record.

37. The method of claim 36, wherein deleting the retrievable record comprises deleting the record when a year has elapsed since the date in the record.

38. The method of claim 36, wherein deleting the retrievable record comprises deleting the record when six months have elapsed since the date in the record.
